(19) United States
(12) Patent Application Publication
(10) Pub. No.: US 2006/0104602 A1
(43) Pub. Date: May 18, 2006

(54) Video data processing conformation with a noise reduction program

(75) Inventors: Chi-Hsien Shih, Chung Ho City (TW); Cheng-Jyh Chang, Chung Ho City (TW); Elvis Lin, Chung Ho City (TW); Jui-Hsiang Yang, Chung Ho City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AverMedia Technologies, Inc.

(21) Appl. No.: 11/071,708

(22) Filed: Mar. 3, 2005

(30) Foreign Application Priority Data
Nov. 12, 2004 (TW) 93134758

(51) Int. Cl. H04N 5/76

(52) U.S. Cl. 386/46

(57) ABSTRACT

A video data process conformation wherein the noise reduction is implemented by a program. The conformation comprises a video decoder and a digital data process system, and a noise reduction program is executed in the digital data process system. The video decoder converts an external analog video data to a digital video data. Then, the digital video data is transmitted into the digital data processing system via a data transmission interface of the digital data processing system, and the noise data of the digital video data is then filtered by the noise reduction program.

### RELATED APPLICATIONS

The present application is based on, and claims priority from, Taiwan Application Serial Number 93134758, filed on Nov. 12, 2004, the disclosure of which is hereby incorporated by reference herein in its entirety.

### BACKGROUND

1. Field of Invention

The present invention relates to a system conformation for processing video data. More particularly, the present invention relates to a system conformation for processing video data with a noise reduction program.

2. Description of Related Art

The integration of various multimedia data is a trend of the data processing technologies nowadays, and the so-called multimedia data is generally without specific reference to the data signal but can represent information, communication and all kinds of audio-visual media. The ultimate information content will be more plentiful and vibrant if the data signal can be processed and utilized on an integrated platform.

In general, a digital data processing system such as personal computer (PC) is often utilized to be a processing platform for multimedia information because the digital data is easier to process and transmit. For example, digital data, audio, video and pictures can be readily edited for turning them into an integrated digital image clip, and then it can be spread via the internet.

The traditional television system still is the most popular video signal propagating system in use. The traditional television system propagates analog video signals to each terminal by a wire or wireless manner, wherein the terminals are the analog video signal receiving and displaying devices such as a display constituted by a cathode ray tube (CRT) or a liquid crystal panel. Presently, the NTSC (National Television System Committee), PAL (Phase Alternating Line) and SECAM (System Electronique Couleur Avec Memoire) are the three analog video standards used.

Because the television system and the digital data processing system are analog and digital signal systems respectively, they are not compatible to directly transmit data to or receive data from each other. Thus, integrating the video clips in a television system with the multimedia data in a digital data processing system is very difficult, and makes the video signal of a television system unable to be turned into a multimedia data source of a digital data processing system.

Therefore, both an analog and a digital video system should be installed when a user requires both analog and digital video for watching or using, which is both expensive and wasteful of space.

FIG. 1 shows a conventional video data processing conformation 100. An analog video data source 110 provides an external analog video data, and then the analog video signal provided from the analog video data source 110 is converted to a digital video data by a video decoder 120. Due to the digital video data converted from the analog video data possibly comprising a noise data which would degrade the quality of image, a noise reduction filter 130 is utilized to filter out the noise data in the digital video data before the digital video data is inputted into a digital data processing system 140 for ensuring the quality of the image processed by the digital data processing system 140.

The video data processing conformation 100 has some drawbacks. For example, each unit of this kind of conformation are all implemented by hardware circuitry, that is, the analog video data source 110, video decoder 120, noise reduction filter 130 and digital data processing system 140; thus, a higher cost is needed for forming the whole conformation. In additional, the noise reduction filter 130, which is designed by hardware circuitry, does not have flexibility in parameter adjusting in general, that is to say, the filter capability of the noise reduction filter 130 is hard to be adjusted for treating noises with different strengths. Besides, some digital video data may be originally stored in a storage unit (not shown in the figure) of the digital data processing system 140. In this case, the noise data in the digital video data stored in the storage unit is not able to be filtered by the noise reduction filter 130, thus limiting the functionality.

According to the foregoing description, a video data processing conformation with characteristics of low cost, high quality, high flexibility, multi-functionality and so on is needed.

### SUMMARY

It is therefore an objective of the present invention to provide a video data processing conformation which is able to process analog and digital video data.

It is another objective of the present invention to provide a video data processing conformation with low cost and high quality.

It is still another objective of the present invention to provide a video data processing conformation wherein the noise filtering parameters can be flexibly adjusted.

It is still another objective of the present invention to provide a video data processing conformation which is able to filter out the noise in the internal and external video data.

According to the foregoing objectives of the invention, the video data processing system comprises a digital data processing system and a video decoder, wherein the video decoder connects with the digital data processing system via a data transmission interface. The video decoder converts an external analog video data to a digital video data at first, and then the digital video data is inputted into the digital data processing system via the data transmission interface. There is a noise reduction program executed in the digital data processing system. The digital video data which is inputted via the data transmission interface should be treated with the noise reduction program for filtering out the undesired noise data in the digital video data, and then the quality of digital image displayed or treated by the digital data processing system can be enhanced.

It is to be understood that both the foregoing general description and the following detailed description are by examples and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a conformation diagram of a conventional analog/digital video data processing system; and

FIG. 2 is a conformation diagram of an analog/digital video data processing system in accordance with an embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

A general idea of the present invention is to add an analog video data processing function into a digital data processing system such that the digital data processing system is able to process and display not only the digital video data but also the analog video data. Because the digital data can be easily processed, a specific software program is executed in the digital data processing system to filter out the undesired noise data in the digital video data to obtain the best image by the least cost.

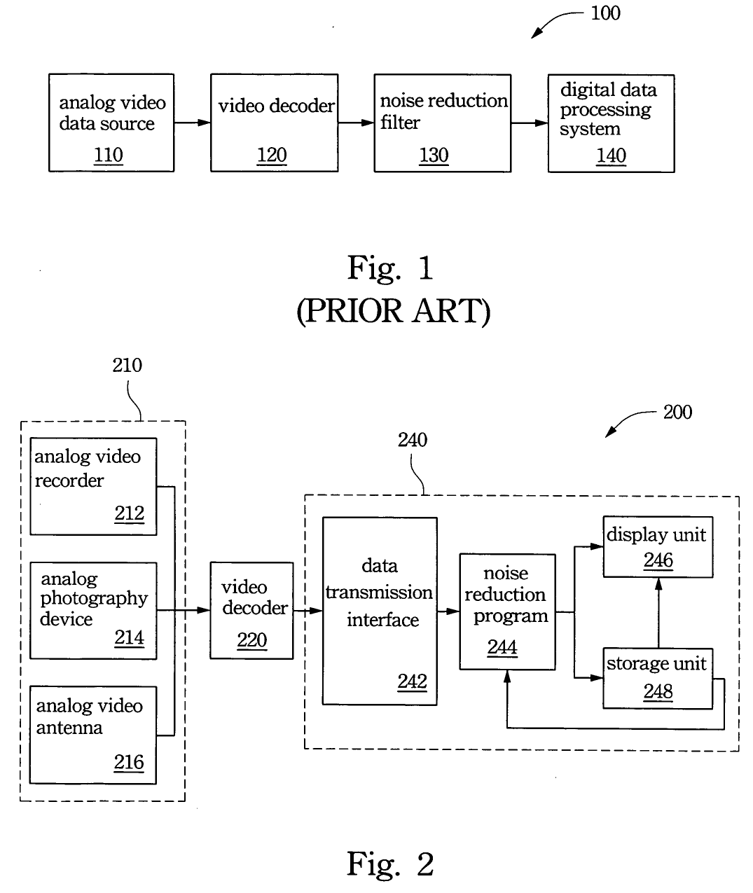

FIG. 2 shows a video data processing conformation 200 according to a preferred embodiment of the present invention. It comprises three parts: an analog video source 210, a video decoder 220 and a digital data processing system 240. Compared with the video data processing conformation 100 shown in FIG. 1, the video data processing conformation 200 does not have the noise reduction filter; thus, the cost can be dropped.

The analog video data source is used to provide the analog video signal, so it may be any analog video device conforming to the analog video standards, wherein the analog video standards may be the common NTSC, PAL or SECAM standard. Three kinds of analog video device can be the analog video data source 210 herein: one is an analog video recorder 212, such as a general home video recorder, one is an analog photography device 214, such as a general camera lens, and one is an analog video antenna 216, such as a general antenna used to receive the television signal, wherein the analog television signal received by the analog video antenna 216 will be transmitted to a demodulator (not shown in the figure) to output an analog video data.

Then, a converting operation should be carried out by the video decoder 220 for converting the analog video data provided by the analog video source 210 to a digital signal, and then the digital signal can be processed by the digital data processing system 240. Therefore, the video decoder 202 has a function which is able to convert an analog signal to a digital signal. The standard of the signal inputted into the video decoder 220 may be the NTSC, PAL or SECAM specification herein, and the digital video standard of the signal outputted from the video decoder 220 may be a general digital video standard such as MDA (Monochrome Display Adapter), CGA (Color Graphic Adapter), HGA (Herculus Graphic Adapter), EGA (Enhanced Graphic Adapter), VGA (Video Graphic Adapter) or Super VGA.

After the analog video data is converted to the digital video data, the digital video data can be inputted into the digital data processing system 240 for further processing. The digital data processing system 240 may be implemented by a general personal computer (PC) or laptop. Thus, a data transmission interface 242, such as the PCI or USB interface in a PC system, is used to communicate with the external units; that is to say, the digital video data outputted from the video decoder 220 will be inputted into the digital data processing system 240 via the data transmission interface 242 of the digital data processing 240.

An analog signal is often affected by various factors to generate the noise, for example, an undesired noise data may very likely be generated in a video data during a signal conversion in an image capture operation, and even if the analog signal is converted into a digital signal, the noise data still exists in the digital signal to degrade the quality of the ultimate video image. Therefore, it is necessary to add a unit for filtering out the noise in the conformation.

In this embodiment, a noise reduction program 244 executed in the digital data processing system 240 is utilized to be the unit for filtering out the noise. The noise reduction program 244 is able to execute a specific algorithm for filtering out the noise data comprised in the digital video data. The noise reduction program 244 is able to filter out the noise data in the digital video data with a complicated and powerful capability; thus, the filtering rate of the noise program 244 is not lower than the filtering rate of the noise reduction filter 130 shown in FIG. 1. Because the operation parameters in the noise reduction program 244 can be readily adjusted by programming for improving or decreasing the noise filtering capability of the noise reduction program 244 to make the image quality accommodate requirements, the noise filtering capability of the noise reduction program according to the present invention is even more powerful than the conventional noise reduction filter 130. The noise reduction program 244 has a characteristic of real-time processing; therefore, it can be executed under a real-time environment in a personal computer and conforms to the commercial requirements.

A desired digital video data is obtained after the process of the noise reduction program 244, and then the digital video data can be selectively transmitted to a display unit 246 or a storage unit 248 in the digital data processing system 240. If the digital video data is transmitted to the display unit 246, the digital video data can be immediately converted and displayed as a digital image, and if the digital video data is transmitted to the storage unit 248, the digital video data can be stored into a data storage device of the digital data processing system 240 for follow-up processes. For example, the follow-up processes comprise the digital video data being transmitted to the display unit 246 from the storage unit 248 and then being displayed as a digital image, or the digital video data can be looped back to the noise reduction program for re-filtering. Similarly, a digital video data which is stored in the storage unit 248 but is not inputted into the digital data processing system 240 via the data transmission interface 242 can also be processed by the noise reduction program 244 for enhancing the quality of all the digital video data in the digital data processing system 240.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A video data processing conformation, comprising:
a video decoder, wherein said video decoder is used to receive an analog video signal and convert the analog video signal to a digital video data, wherein the analog video data is provided by an analog video recorder, an analog photography device or a demodulator;
a digital data processing system, wherein said digital data processing system receives the digital video data via a data transmission interface; and
a noise reduction program executed in said digital data processing system, wherein said noise reduction program is used to filter out a noise data in the digital video data.

2. The video data processing conformation of claim 1, wherein said demodulator is used to receive an analog television signal from an analog video antenna and output the analog video data.

3. The video data processing conformation of claim 1, wherein said digital data processing system is a personal computer (PC) or laptop system.

4. The video data processing conformation of claim 1, wherein said data transmission interface conforms to the PCI or USB standard in a personal computer system.

5. The video data processing conformation of claim 1, wherein said noise reduction program executes an algorithm which is able to filter out the noise data in the digital video data for giving said noise reduction program a real-time processing capability, and the operation parameters of said noise reduction program can be adjusted by programming for adjusting the noise filtering capability of said noise reduction program.

6. The video data processing conformation of claim 1, further comprising a display unit in said digital data processing system for displaying a digital image in accordance with the digital video data processed by said noise reduction program.

7. The video data processing conformation of claim 1, further comprising a storage unit in said digital data processing system for storing the digital video data processed by said noise reduction program.

8. The video data processing conformation of claim 7, wherein said noise reduction program is able to receive and process the digital video data from said storage unit.

9. The video data processing conformation of claim 7, further comprising a display unit in said digital data processing system for displaying a digital image in accordance with the digital video data from said storage unit.

10. A method for processing a video data, comprising:
providing an analog video data by an analog video recorder, an analog photography device or a demodulator;
converting the analog video data to a digital video data; and
filtering out a noise data in the digital video data by a noise reduction program.

11. The method of claim 10, wherein said demodulator is used to receive an analog television signal from an analog video antenna and output the analog video data.

12. The method of claim 10, wherein said noise reduction program executes an algorithm which is able to filter out the noise data in the digital video data for giving said noise reduction program a real-time processing capability, and the operation parameters of said noise reduction program can be adjusted by programming for adjusting the noise filtering capability of said noise reduction program.

13. A video data processing conformation, comprising:
a digital data processing system;
a storage unit set in said digital data processing system, wherein said storage unit is used to output a digital video data comprising a noise data;
a noise reduction program executed in said digital data processing system, wherein said noise reduction program is used to filter out the noise data from the digital video data; and
a display unit set in said digital data processing system, wherein said display unit is used to display a digital image in accordance with the digital video data processed by said noise reduction program.

14. A method for processing a video data, comprising:
providing a digital video data comprising a noise data;
filtering out the noise data in the digital video data by a noise reduction program; and
displaying a digital image in accordance with the digital video data processed by the said noise reduction program.
